(19) United States
(12) Patent Application Publication
(10) Pub. No.: US 2010/0172225 A1
(43) Pub. Date: Jul. 8, 2010

(54) INFORMATION RECORDING/REPRODUCING APPARATUS

(76) Inventors: Atsushi Hirayama, Osaka (JP); Masaharu Imura, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/663,777

(22) PCT Filed: Jun. 16, 2008
(86) PCT No.: PCT/JP2008/001542

§ 371 Date: Dec. 9, 2009

(30) Foreign Application Priority Data
Jun. 28, 2007 (JP) 2007-169885

(51) Int. Cl. G11B 7/12

(52) U.S. Cl. 369/47.53; G9B/7

(57) ABSTRACT

An information recording/reproduction apparatus which can reduce the time required for recording power adjustment and suppress consumption of PCA is provided. The information recording/reproduction apparatus is provided with an asymmetry detection circuit which detects a recording state that varies according to a recording power, from a reproduction signal reproduced from a recording medium, a recording power setting circuit which performs recording power adjustment, a reproduction clock generation circuit which generates a reproduction clock based on the reproduction signal, a phase error detection circuit which detects a phase error between the reproduction signal and the reproduction clock, a pattern detection circuit which detects patterns of the reproduction signal, a pattern phase error averaging circuit which obtains an average of phase errors for each pattern, a recording light-emission waveform adjustment circuit which adjusts a recording light-emission waveform based on an output of the pattern phase error averaging circuit, and a recording power adjustment execution judgment circuit which controls the recording power setting circuit so as not to perform recording power adjustment when the detected recording state is within the predetermined range.

### TECHNICAL FIELD

The present invention relates to an information recording/reproducing apparatus for recording information in recording media such as optical discs.

### BACKGROUND ART

In recent years, optical disc devices have been used in the field of information recording and reproduction. The optical disc devices use pigment system recording media or phase-change system recording media, and record information on the recording media by a mark edge recording method having information at front and rear edges of marks formed on the recording media.

When performing recording onto the pigment system recording media or the phase-change system recording media, the recording conditions are varied depending on the ambient temperature, the type of the recording media, or the linear velocity, and the recording power and the pulse time width rule (hereinafter referred to as “write strategy”) of a laser light-emission waveform as a recording light-emission waveform for obtaining an optimum recording quality are also varied. Therefore, recording learning including write strategy adjustment and recording power adjustment must be performed in advance of data recording to find recording conditions with which the optimum recording quality can be obtained.

With respect to the write strategy, for example, a pulse control system (Multi Pulse) and a non-multi pulse system (Non Multi Pulse) have been standardized as described in DVD-R specifications (DVD Specifications for Recordable Disc for General).

Further, with respect to the pigment system recording media and the phase-change system recording media, generally, test recording called “Optimum Power Control” (hereinafter referred to as “OPC”) is performed in advance of data recording to optimize the recording power.

The OPC is performed by recording predetermined data in a specific area called “Power Calibration Area” (hereinafter referred to as “PCA”) in a recording medium, and reproducing the data, as disclosed in Patent Document 1. To be specific, test recording is performed with the recording power being varied in several stages, using test data of a predetermined pattern comprising marks and spaces which are three times (3T) to fourteen times (14T) as long as a channel clock period T that are the shortest mark length and the longest mark length used in recording data, respectively, and then this test pattern is reproduced to calculate an optical recording power with reference to such as an asymmetry which is one of indexes for evaluating the recording quality at each recording power.

The asymmetry shows the symmetry property of a reproduction signal generated from reflected light from the optical disc, and it is used as an index indicating the degree of recording power.

FIG. 9 shows a reproduction signal after AC coupling.

Using a positive side (space side) peak level A1 and a negative side (mark side) peak level A2, an asymmetry β after AC coupling is given as follows:

β=(A1+A2)÷(A1−A2)

A1+A2: a difference between the positive and negative peak levels of the reproduction signal after AC coupling

A1−A2: an amplitude value of the reproduction signal after AC coupling

When the recording power is decreased, A1+A2 becomes negative, and the asymmetry β also becomes negative. Since the recording power margin is deteriorated unless the asymmetry β is near 0, the recording power must be set so that the asymmetry β is within a predetermined range (e.g., within several percents).

Next, write strategy adjustment in the conventional optical disc device will be described with reference to figures.

FIG. 2 shows the configuration of the conventional optical disc device 200.

The conventional optical disc device 200 has an optical head 2 for reading and writing data from and in an optical disc 1. When reading data, reflected light applied to the optical disc 1 is converted into a reproduction signal corresponding to the recorded data by the optical head 2.

The reproduction signal is waveform-shaped by a waveform equalizer 3 and then binarized by a binarization circuit 4 to be a reproduction data signal. A phase comparator 5 detects a phase error between the reproduction data signal and a reproduction clock signal on the basis of the inputted reproduction data signal. A lower pass filter (hereinafter referred to as “LPF”) 6 determines a frequency to be followed by a voltage controlled oscillator 7 (hereinafter referred to as “VCO”) from the phase error detected by the phase comparator 5. Thereby, the VCO 7 is controlled to generate a reproduction clock signal.

As described above, in the conventional optical disc device 200, a phase looked loop circuit (hereinafter referred to as “PLL circuit”) 8 is configured by the phase comparator 5, the LPF 6, and the VCO 7. In the PLL circuit 8, the reproduction clock signal outputted from the VCO 7 is feedback-controlled so that the average of the phase errors between the reproduction clock signal and the reproduction data signal approaches zero.

While the reproduction clock signal is thus generated in synchronization with the reproduction data signal, even when the average phase error between the reproduction data signal and the reproduction clock signal is reduced as described above a phase error between the reproduction data signal and the reproduction clock signal occurs at each polarity inversion position of the reproduction data signal. This phase error is caused by that recording parameters such as write strategy are inappropriate, and it occurs due to shifting of a mark edge from an appropriate position.

Accordingly, by detecting continual phase error amounts as the phase error amounts at the respective polarity inversion positions, it is possible to detect in which direction and to what degree the positions of the edges of the corresponding marks deviate with respect to an ideal mark edge position (the position where the phase error from the reproduction clock signal is zero).

In this specification, the continual phase error amount indicates a deviation on time axis, between the reproduction clock signal and each polarity inversion position of each mark edge. On the other hand, a pattern average phase error amount indicates a value obtained by averaging the continual phase error amounts. Thus, the continual phase error amount and the pattern average phase error amount are distinguished from each other.

Next, a description will be given of optimization of the recording parameters using the phase error in the conventional optical disc device 200.

A pattern detection circuit 9 identifies a signal pattern corresponding to a combination of mark lengths and space lengths, using the reproduction data signal supplied from the binarization circuit 4 and the reproduction clock signal supplied from the VCO 7.

A pattern phase error averaging circuit 10 obtains a pattern average phase error amount as an average phase error amount for each pattern, which is obtained by averaging the continual phase error amounts for each combination of the signal pattern, based on the signal patterns outputted from the pattern detection circuit 9 and the continual phase error amounts outputted from the phase comparator 5.

A variable edge determination circuit 11 judges whether the pattern average phase error amount is within a predetermined range or not, for each combination of mark lengths and space lengths, based on the input from the pattern phase error averaging circuit 10, thereby to determine an edge at which the recording parameter should be changed.

When the phase error amount is within the predetermined range, it is judged that the recording parameter corresponding to the combination is appropriate, and the recording parameter is not changed. On the other hand, when the phase error amount is outside the predetermined range, it is judged that the recording parameter corresponding to the combination must be changed. For example, if the pattern average phase error amount is not within ±5% with respect to the channel clock period T, the variable edge determination circuit 11 instructs a recording pulse generation circuit 12 to change only the recording parameter of the edge of the signal pattern which has been judged to be changed so that the pattern average phase error amount should be zero.

Based on the instruction from the variable edge determination circuit 11, the recording pulse generation circuit 12 adjusts the write strategy to generate a recording pulse, and a laser driving circuit 13 drives the laser of the optical head 2 based on the input from the recording pulse generation circuit 12.

Further, a power adjustment execution circuit 17 determines a recording power based on the asymmetry value detected by the asymmetry detection circuit 14.

Next, a description will be given of classification of the signal patterns at recording, a phase error value table, and a recording parameter table, with reference to FIGS. 3 and 4.

In FIG. 3, (a) shows a recording clock to be a reference for generating a recording pulse, (b) shows recording data for forming marks and spaces, (c) shows a laser driving waveform inputted to the laser driving circuit, and (d) shows marks and spaces formed on the optical disc. In this example, a pattern comprising continuous 3T mark, 3T space, 6T mark, 3T space, and 3T mark is recorded and reproduced. Further, (e) shows a reproduction signal reproduced from the optical disc, (f) shows a reproduction data signal obtained by binarization based on the reproduction signal, and (g) shows a reproduction clock which is generated in the PLL circuit 8 based on the binarized reproduction data signal.

In FIG. 3, assuming that a mark to be a reference is 6T, a front-edge space and a rear-edge space of a current mark have the lengths of 3T, respectively. Therefore, a signal pattern at the front edge of the current mark comprises 3T space (hereinafter abbreviated as “s”) and 6T mark (hereinafter abbreviated as “m”), and hereinafter, this pattern is referred to as a 3s6m pattern. Further, a signal pattern at the rear edge of the current mark comprises 6T mark and 3T space, and hereinafter, this pattern is referred to as a 6m3s pattern.

The phase comparator 5 continually compares the polarity inversion position of the reproduction data signal (f) with the reproduction clock signal (g) every time the polarity of the reproduction data signal (f) is inverted, thereby to obtain the continual phase error amounts.

The pattern detection circuit 9 detects that the front-edge recording pattern is a 3s6m pattern from the current mark length to be a reference and the front-edge space length, based on the reproduction data signal (f) and the reproduction clock signal (g). Similarly, it detects that the rear-edge recording pattern is a 6m3s pattern from the current mark length and the rear-edge space length.

It is recognized that the continual phase error amount at the front edge of the current mark is the continual phase error amount (3s6mTd) of the 3s6m pattern from the recording pattern detected by the pattern detection circuit 9 and the continual phase error amounts, and that the continual phase error amount at the rear edge is the continual phase error amount (6m3sTd) of the 6m3s pattern.

The pattern phase error averaging circuit 10 obtains a pattern average phase error amount of the 3s6m pattern from the integrated value of the continual phase error amount (3s6mTd) of the 3s6m pattern, and the number of occurrences of the 3s6m pattern. Similarly, the pattern average phase error amount of each recording pattern is obtained.

FIGS. 4(a) and 4(b) are diagrams illustrating examples of pattern phase error tables indicating the pattern average phase error amounts of the current mark to be a reference, wherein 4(a) shows a table of the mark front-edge average phase error amounts and 4(b) shows a table of mark rear-edge average phase error amounts.

For example, LA 36 shows the pattern average phase error amount of the 3s6m pattern at the front edge of the mark. Further, for example, TA36 shows the pattern average phase error amount of the 6m3s pattern at the rear edge of the mark. As for the data patterns relating to long marks and long spaces exceeding 6T, since such long marks and long spaces have approximately the same phase error amount, the phase error amounts relating to marks and spaces of 7T and more are not measured in this time example.

FIGS. 4(c) and 4(d) are diagrams illustrating examples of tables of recording parameters at the front edge and the rear edge of the current mark, which correspond to the signal patterns of FIGS. 4(a) and 4(b), respectively.

For example, LB 36 shows the recording parameter in the case of having a mark length of 6T at the front edge of the mark and a space length of 3T immediately before the mark (3s6m pattern). Further, for example, TB36 shows the recording parameter in the case of having a mark length of 6T at the rear edge of the mark and a space length of 3T immediately after the mark (6m3s pattern).

The write strategy adjustment in the optical disc device is to control the values in the recording parameter tables shown in FIGS. 4(c) and 4(d) so that the average value of the phase errors of all the recording patterns shown in FIGS. 4(a) and 4(b) approach zero.

Next, the recording learning method in the conventional optical disc device 200 will be described with reference to FIGS. 5, 6, and 7.

FIG. 5 is a flowchart illustrating the recording learning method in the optical disc device 200.

First of all, the optical disc device 200 performs setting of initial recording parameters and setting of initial recording power (step S501). The initial recording parameters and the initial recording power may have initial values in a recommended write strategy for each disc which is included in information of land prepit (LPP) in the case of DVD-R, or in firmware.

Next, recording power adjustment RPA is carried out (step S502). As for this recording power adjustment RPA, for example, recording is performed with the recording power being varied for each 4% within the range of ±20% centering around a set recording power.

FIG. 6 shows an example of recording power during the recording power adjustment.

Assuming that the set recording power is 20 mW, the recording power is increased stepwise by 0.8 mW from 16 mW, and thus the test data comprising the recording power adjustment patterns is recorded with the eleven steps of recording powers up to 24.0 mW.

Next, asymmetry values β are measured for the test data recorded with the respective recording powers, through the write strategy adjustment to be described later (step S503), and the measured asymmetry values β are compared with a target asymmetry value to determine a recording power value at which the target asymmetry is obtained, and the determined recording power is set as a recording power (step S504).

Next, the write strategy adjustment WSA will be described.

For example, it is assumed that all the initial recording parameters are zero as shown in FIGS. 7(a) and 7(b). That is, it is assumed that, among the recording parameters, the recording parameters indicating the fundamental amounts such as the top pulse width and the last pulse width are included in the above-described recommended write strategy, and the initial values of the recording parameters used for performing minute adjustment in the combination patterns comprising space lengths and mark lengths are all 0. Further, it is assumed that the test recording data for the write strategy are the recording patterns including all the combinations of marks and spaces.

In the write strategy adjustment WSA, initially, a recording pulse is generated, and the laser is driven to perform test recording (step S505).

Next, the phase errors in the test recorded portions are measured, and the pattern average phase error amounts are obtained for the respective recording patterns shown in FIGS. 4(a) and 4(b) (step S506).

Next, it is judged whether all the phase error amounts of the pattern average phase error amounts are within a predetermined range or not (step S507), and the recording learning is ended when the phase error amounts are within the range.

On the other hand, when the phase error amounts are not within the range, the variable edge determination circuit 11 varies the recording parameter of the edge having a large phase error so that the phase error should be zero. That is, the edge of the signal pattern having the largest pattern average phase error amount is determined as an edge to be changed (step S508).

Thereafter, it is judged whether the write strategy adjustment WSA has been performed by a predetermined number of times or not with the recording power that is determined by the recording power adjustment RPA (step S509), and when it is less than the predetermined number of times, the write strategy adjustment WSA is again performed. When it has reached the predetermined number of times, the recording power adjustment RPA is again performed based on the judgment that the asymmetry deviates due to the change of the write strategy.

In this recording power adjustment RPA, the recording power which has been determined in the previous recording power adjustment RPA and used for the write strategy adjustment WSA is used as a set recording power, and recording is performed with the recording power being varied stepwise as already described for the previous recording power adjustment, and then asymmetries β at the respective recording powers are obtained to determine and set a recording power at which the target asymmetry is obtained.

In this way, the recording power adjustment RPA and the write strategy adjustment WSA are repeated until all the pattern phase error amounts of the combinations of recording patterns become smaller than the predetermined value.

FIGS. 7(c) and 7(d) show examples of recording parameter tables in the case where all the pattern phase error amounts become lower than the predetermined value. For example, the recording parameter value LB36 of the 3s6m pattern is shifted by −0.15T from the initial value 0.

FIGS. 7(c) and 7(d) show examples of recording parameter tables in the case where all the pattern phase error amounts become lower than the predetermined value. For example, the recording parameter value LB36 of the 3s6m pattern is shifted by −0.15T from the initial value 0.

Although not described in the flowchart of FIG. 5, the total number of executions of the recording power adjustment RPA and the write strategy adjustment WSA is separately judged, and if all the pattern phase error amounts are not smaller than the predetermined value even after the predetermined number of executions of RPA and WSA, the operation is ended as recording learning error.

Patent Document 1: Japanese Published Patent Application No. 2002-298358

### DISCLOSURE OF THE INVENTION

### Problems to be Solved by the Invention

Conventionally, since the recording power adjustment is performed every time the write strategy adjustment is repeated by the predetermined number of times, the recording learning takes time, and the phase errors which have been adjusted by the write strategy adjustment are undesirably deviated if the recording power is varied due to the recording power adjustment.

Furthermore, since a recording medium which can perform recording only once, such as a DVD-R, has only a predetermined amount of PCA, the number of executions of recording learning must be increased with reducing the consumption of the PCA by the recording learning.

The present invention is made to solve the above-described problems and has for its object to provide an information recording/reproduction apparatus which can reduce the time required for recording learning, and suppress the consumption of the PCA.

It is another object of the present invention to provide an information recording/reproduction apparatus which can reduce the deviation of the phase error due to the recording power adjustment to perform more accurate write strategy adjustment.

It is a further object of the present invention to provide an information recording/reproduction apparatus which can restrict the variable range of the recording power in the recording power adjustment, suppress the consumption of the PCA, and reduce the time required for the recording power adjustment.

### Measures to Solve the Problems

In order to solve the above-described problems, according to claim 1 of the present invention, there is provided an information recording/reproduction apparatus for reproducing information from a waveform signal which is recorded by a mark edge recording method having information at front edges and rear edges of marks formed on a recording medium, the apparatus comprising: a laser driving circuit which irradiate a recording plane of the recording medium with laser light to record recording data; an asymmetry detection circuit which detects a recording state that varies according to a recording power, from a reproduction signal reproduced from the recording medium; a recording power setting circuit which performs recording power adjustment based on an output of the asymmetry detection circuit; a reproduction clock generation circuit which generates a reproduction clock based on the reproduction signal; a phase error detection circuit which detects a phase error between the reproduction signal and the reproduction clock, based on the reproduction signal and the reproduction clock; a pattern detection circuit which detects patterns of the reproduction signal, based on the reproduction signal and the reproduction clock; a pattern phase error averaging circuit which obtains an average of phase errors for each pattern, from an output of the pattern detection circuit and an output of the phase error detection circuit; a recording light-emission waveform adjustment circuit which adjusts a recording light-emission waveform based on an output of the pattern phase error averaging circuit; and a recording power adjustment execution judgment circuit which controls the recording power setting circuit so as to perform recording power adjustment when the detected recording state is outside a predetermined range, and controls the recording power setting circuit so as not to perform recording power adjustment when the detected recording state is within the predetermined range.

According to claim 2 of the present invention, in the information recording/reproduction apparatus defined in claim 1, the recording power adjustment execution judgment circuit controls the recording power setting circuit so as to perform recording power adjustment when the detected recording state is outside a range corresponding to a recording power of an adjustment error in recording power adjustment, and controls the recording power setting circuit so as not to perform recording power adjustment when the detected recording state is within the range corresponding to the recording power of the adjustment error in the recording power adjustment.

According to claim 3 of the present invention, there is provided an information recording/reproduction apparatus for reproducing information from a waveform signal which is recorded by a mark edge recording method having information at front edges and rear edges of marks formed on a recording medium, the apparatus comprising: a laser driving circuit which irradiate a recording plane of the recording medium with laser light to record recording data; an asymmetry detection circuit which detects a recording state that varies according to a recording power, from a reproduction signal reproduced from the recording medium; a recording power setting circuit which performs recording power adjustment based on an output of the asymmetry detection circuit; a reproduction clock generation circuit which generates a reproduction clock based on the reproduction signal; a phase error detection circuit which detects a phase error between the reproduction signal and the reproduction clock, based on the reproduction signal and the reproduction clock; a pattern detection circuit which detects patterns of the reproduction signal based on the reproduction signal and the reproduction clock; a pattern phase error averaging circuit which obtains an average of phase errors for each pattern, from an output of the pattern detection circuit and an output of the phase error detection circuit; a standardized pattern phase error calculation circuit which standardizes an output of the pattern phase error averaging circuit with reference to a phase error average value of a shortest mark; a recording light-emission waveform adjustment circuit which adjusts a recording light-emission waveform based on an output of the standardized pattern phase error calculation circuit; and a recording power adjustment execution judgment circuit which controls the recording power setting circuit so as to perform recording power adjustment when the detected recording state is outside a predetermined range, and controls the recording power setting circuit so as not to perform recording power adjustment when the detected recording state is within the predetermined range.

According to claim 4 of the present invention, in the information recording/reproduction apparatus defined in claim 3, the recording power adjustment execution judgment circuit controls the recording power setting circuit so as to perform recording power adjustment when the detected recording state is outside a range corresponding to a recording power of an adjustment error in recording power adjustment, and controls the recording power setting circuit so as not to perform recording power adjustment when the detected recording state is within the range corresponding to the recording power of the adjustment error in the recording power adjustment.

According to claim 5 of the present invention, in the information recording/reproduction apparatus defined in claim 3 or 4, the standardized pattern phase error calculation circuit standardizes the output of the pattern phase error averaging circuit with reference to the phase error average values of a pattern comprising a shortest mark and a shortest space at an front edge of the shortest mark and a pattern comprising a shortest mark and a shortest space at a rear edge of the shortest mark.

According to claim 6 of the present invention, there is provided an information recording/reproduction apparatus for reproducing information from a waveform signal which is recorded by a mark edge recording method having information at front edges and rear edges of marks formed on a recording medium, the apparatus comprising: a laser driving circuit which irradiate a recording plane of the recording medium with laser light to record recording data; an asymmetry detection circuit which detects a recording state that varies according to a recording power, from a reproduction signal reproduced from the recording medium; a recording power setting circuit which performs recording power adjustment based on an output of the asymmetry detection circuit; a reproduction clock generation circuit which generates a reproduction clock based on the reproduction signal; a phase error detection circuit which detects a phase error between the reproduction signal and the reproduction clock, based on the reproduction signal and the reproduction clock; a pattern detection circuit which detects patterns of the reproduction signal based on the reproduction signal and the reproduction clock; a pattern phase error averaging circuit which obtains an average of phase errors for each pattern, from an output of the pattern detection circuit and an output of the phase error detection circuit; a recording light-emission waveform adjustment circuit which adjusts a recording light-emission waveform based on an output of the pattern phase error averaging circuit; a recording light-emission waveform adjustment execution confirmation circuit which judges whether or not a recording light-emission waveform relating to a shortest mark has been adjusted in the recording light-emission waveform adjustment circuit; and a recording power adjustment execution judgment circuit which receives the result of judgment by the recording light-emission waveform adjustment execution confirmation circuit, and controls the recording power setting circuit so as to perform recording power adjustment when the recording light-emission waveform relating to the shortest mark is adjusted, and controls the recording power setting circuit so as not to perform recording power adjustment when the recording light-emission waveform relating to the shortest mark is not adjusted.

According to claim 7 of the present invention, in the information recording/reproduction apparatus defined in claim 6, the recording light-emission waveform adjustment execution confirmation circuit confirms whether the recording light-emission waveforms of a pattern comprising a shortest mark and a shortest space at an front edge of the shortest mark and a pattern comprising a shortest mark and a shortest space at a rear edge of the shortest mark are adjusted or not.

According to claim 8 of the present invention, there is provided an information recording/reproduction apparatus for reproducing information from a waveform signal which is recorded by a mark edge recording method having information at front edges and rear edges of marks formed on a recording medium, the apparatus comprising: a laser driving circuit which irradiate a recording plane of the recording medium with laser light to record recording data; an asymmetry detection circuit which detects a recording state that varies according to a recording power, from a reproduction signal reproduced from the recording medium; a recording power setting circuit which performs recording power adjustment based on an output of the asymmetry detection circuit; a reproduction clock generation circuit which generates a reproduction clock based on the reproduction signal; a phase error detection circuit which detects a phase error between the reproduction signal and the reproduction clock, based on the reproduction signal and the reproduction clock; a pattern detection circuit which detects patterns of the reproduction signal based on the reproduction signal and the reproduction clock; a pattern phase error averaging circuit which obtains an average of phase errors for each pattern, from an output of the pattern detection circuit and an output of the phase error detection circuit; a recording light-emission waveform adjustment circuit which adjusts a recording light-emission waveform based on an output of the pattern phase error averaging circuit; and a recording power adjustment range determination circuit which controls the recording power setting circuit so as to perform recording power adjustment when the detected recording state is outside a predetermined range, and controls the recording power setting circuit so as not to perform recording power adjustment when the detected recording state is within the predetermined range, and when performing control so as to perform recording power adjustment, the recording power adjustment range determination circuit setting the recording power variable range in the recording power adjustment to be lower than a set recording power when the detected recording state is larger than a predetermined value, and setting the recording power variable range in the recording power adjustment to be higher than the set recording power when the detected recording state is smaller than the predetermined value.

According to claim 9 of the present invention, in the information recording/reproduction apparatus defined in claim 8, the recording power adjustment range determination circuit controls the recording power setting circuit so as to perform recording power adjustment when the detected recording state is outside a recording state corresponding to a recording power of an adjustment error in the recording power adjustment, and controls the recording power setting circuit so as not to perform recording power adjustment when the detected recording state is within the recording state corresponding to the recording power of the adjustment error in the recording power adjustment.

### EFFECTS OF THE INVENTION

According to the information recording/reproduction apparatus of the present invention, an asymmetry is measured after the write strategy is adjusted, and recording power adjustment is not executed if the measured asymmetry value is lower than a predetermined value. Therefore, the frequency of recording power adjustment in recording learning can be reduced, whereby the time required for recording learning can be shortened, and the consumption of PCA can be suppressed.

Further, according to the information recording/reproduction apparatus of the present invention, since the write strategy is adjusted with reference to a phase error of a shortest mark length which relates to the asymmetry, asymmetry variation due to the write strategy adjustment can be suppressed. Thereby, the recording power adjustment amount by the recording power adjustment is reduced, and thus a deviation of the phase error due to the recording power adjustment is reduced, resulting in more accurate write strategy adjustment.

Further, according to the information recording/reproduction apparatus of the present invention, after the write strategy is adjusted, it is confirmed whether a recording parameter of a shortest mark length which relates to the asymmetry is adjusted in the write strategy adjustment or not, and when the recording parameter of the shortest mark length is not adjusted, recording power adjustment is not performed assuming less asymmetry variation. Therefore, the frequency of recording power adjustment in recording learning can be reduced, whereby the time required for recording learning can be shortened, and the consumption of PCA can be reduced.

Further, according to the information recording/reproduction apparatus of the present invention, since an asymmetry is measured after the write strategy is adjusted, a difference value between the asymmetry value at the currently set recording power and the target asymmetry value can be detected. Therefore, by restricting the recording power variable range in the recording power adjustment according to the detected difference value, the consumption of PCA can be suppressed and the time required for recording power adjustment can be reduced.

### BRIEF DESCRIPTION OF THE DRAWINGS

FIG. 1 is a block diagram illustrating an optical disc device according to a first embodiment of the present invention.

FIG. 2 is a block diagram illustrating the conventional optical disc device.

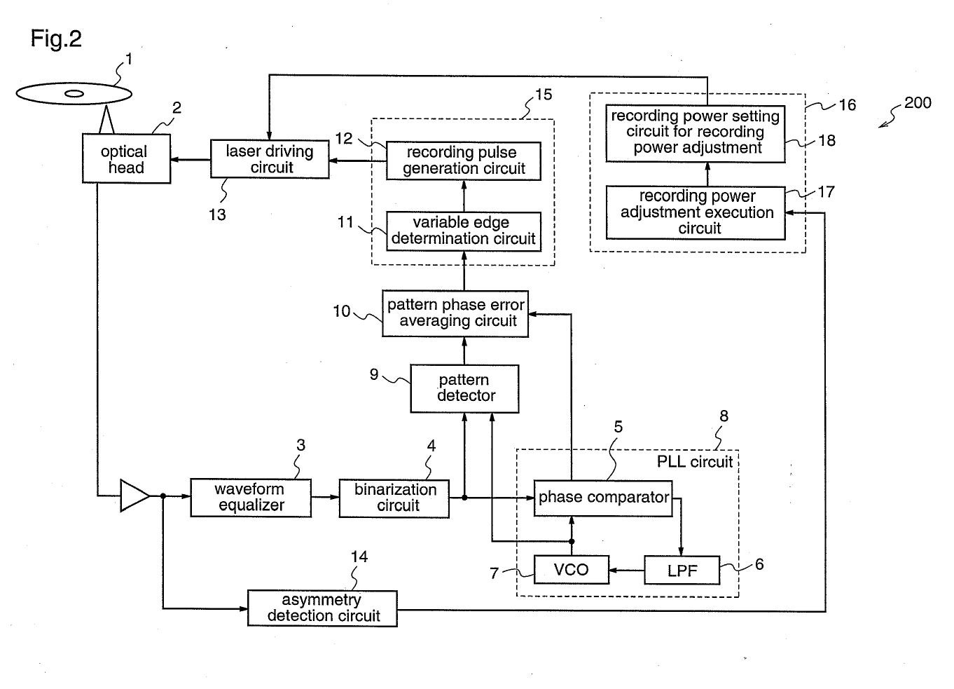

FIG. 3 is a diagram for explaining the relations among a recording clock, recording data, a laser drive waveform, marks and spaces on an optical disc, a reproduction waveform, a reproduction data signal, and a reproduction clock signal.

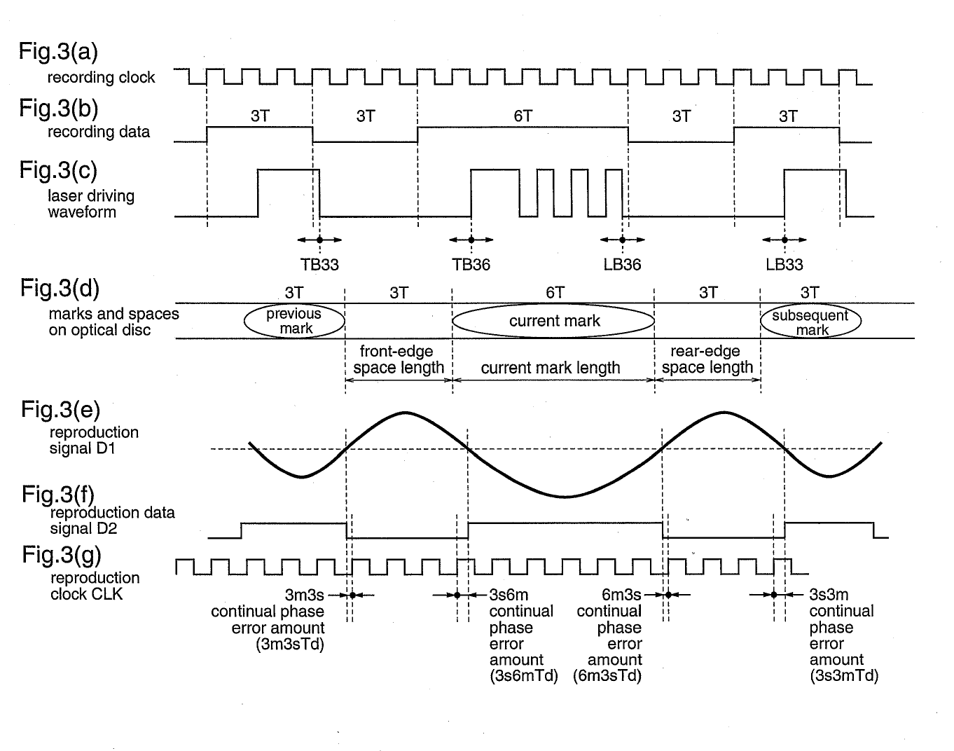

FIG. 4 is a diagram for explaining a pattern phase error table and a recording parameter table.

FIG. 5 is a flowchart of recording learning according to the conventional technique.

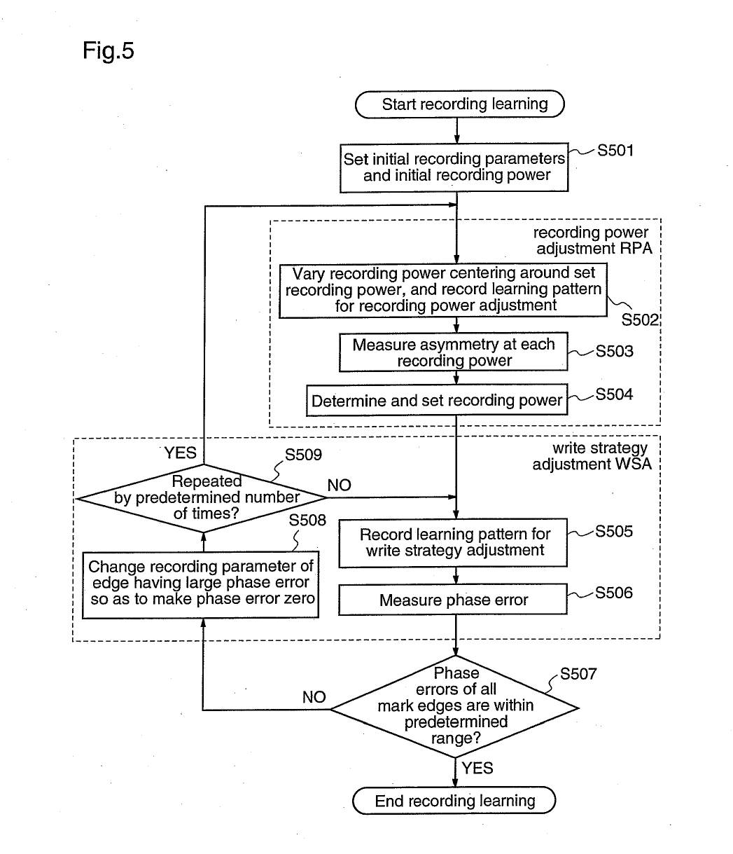

FIG. 6 is a diagram for explaining the conventional recording power adjustment.

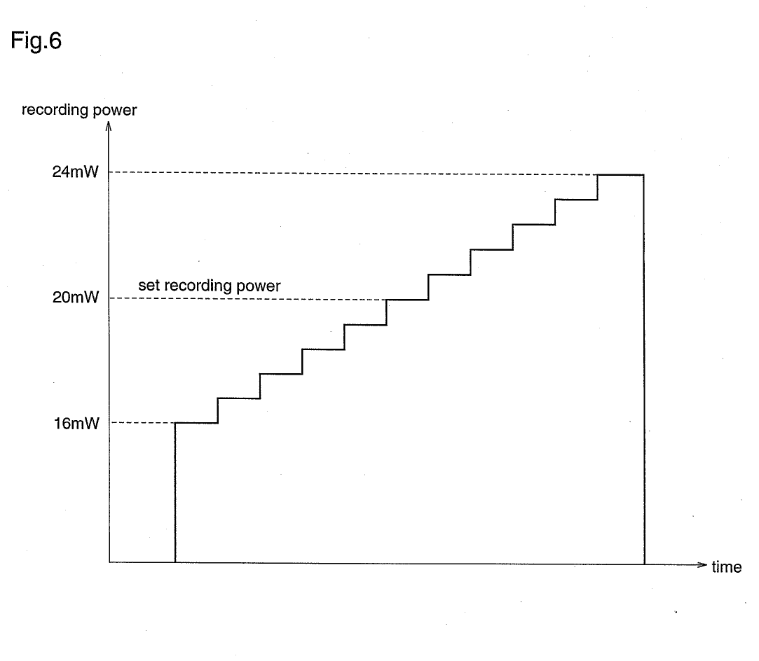

FIG. 7 is a diagram illustrating an example of a recording parameter table.

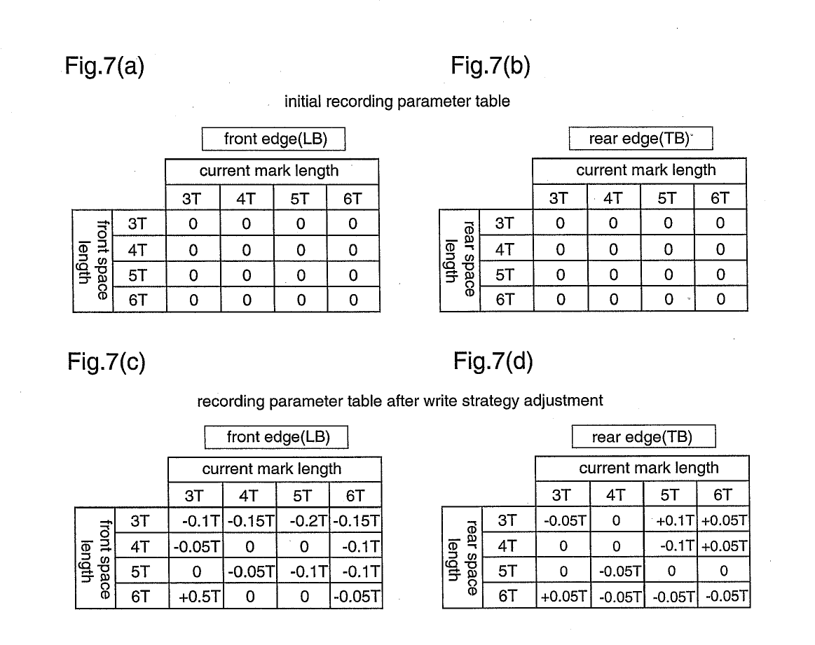

FIG. 8 is a flowchart of recording learning according to a first embodiment of the present invention.

FIG. 9 is a diagram for explaining an asymmetry detection method.

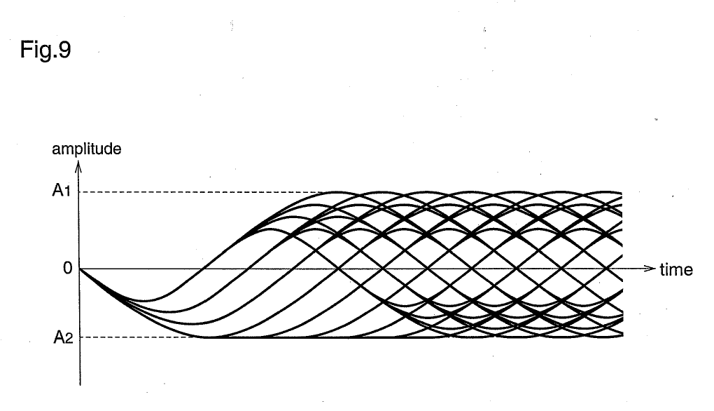

FIG. 10 is a block diagram illustrating an optical disc device according to a second embodiment of the present invention.

FIG. 11 is a block diagram illustrating an optical disc device according to a third embodiment of the present invention.

FIG. 12 is a block diagram illustrating an optical disc device according to a fourth embodiment of the present invention.

FIG. 13 is a flowchart of recording learning according to the second embodiment.

FIG. 14 is a flowchart of recording learning according to the third embodiment.

FIG. 15 is a flowchart of recording learning according to the fourth embodiment.

FIG. 16 is a diagram illustrating an example of a pattern phase error table.

FIG. 17 is a diagram for explaining recording power adjustment according to the fourth embodiment.

### DESCRIPTION OF REFERENCE NUMERALS

1 . . . optical disc
2 . . . laser driving circuit
3 . . . waveform equalizer
4 . . . binarization circuit
5 . . . phase comparator
6 . . . LPF
7 . . . VCO
8 . . . PLL circuit
9 . . . pattern detector
10 . . . pattern phase error averaging circuit
11 . . . variable edge determination circuit
12 . . . recording pulse generation circuit
13 . . . laser driving circuit
14 . . . asymmetry detection circuit
15 . . . recording light-emission waveform adjustment unit
16 . . . recording power setting unit
17 . . . recording power adjustment execution circuit
18 . . . recording power setting circuit for recording power adjustment
19 . . . recording power adjustment execution judgment circuit
20 . . . standardized pattern phase error calculation circuit
21 . . . shortest mark edge variable confirmation circuit
22 . . . variable edge recording power adjustment execution judgment circuit
23 . . . recording power adjustment range determination circuit

### BEST MODE TO EXECUTE THE INVENTION

Hereinafter, preferred embodiments of the present invention will be described with reference to the drawings.

### Embodiment 1

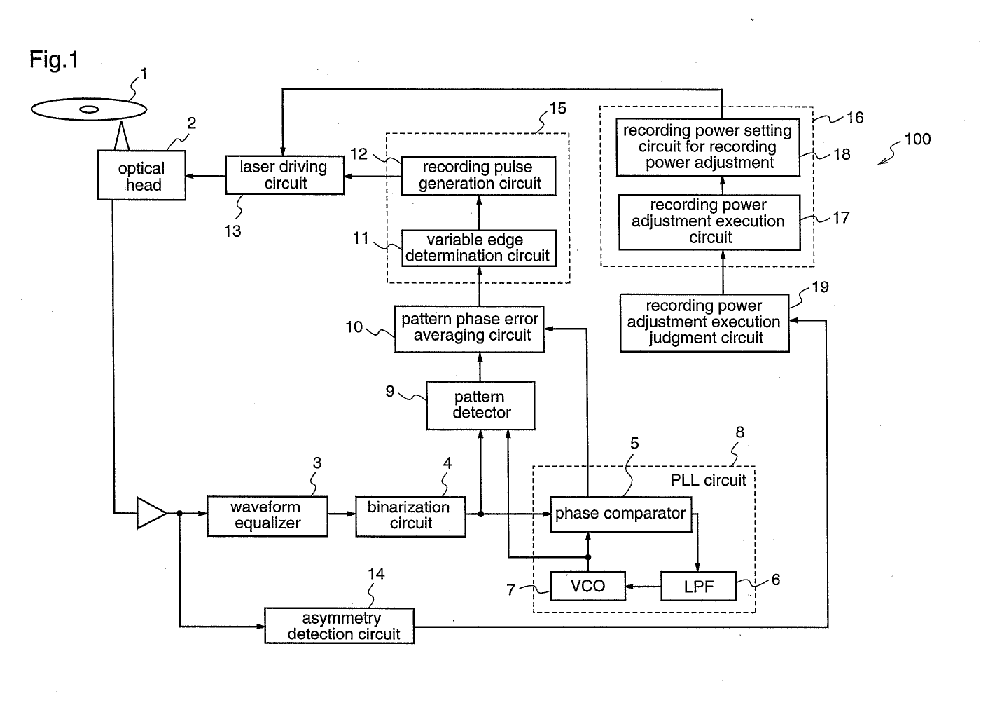

FIG. 1 is a block diagram illustrating the configuration of an optical disc device as an information recording/reproduction apparatus according to a first embodiment of the present invention.

With reference to FIG. 1, reference numeral 1 denotes an optical disc as a recording medium, 2 denotes an optical head which writes or reads data in or from the optical disc 1, 3 denotes a waveform equalizer which performs waveform shaping for a reproduction signal that is read from the optical disc 1, and 4 denotes a binarization circuit which binarizes the reproduction signal to generate a reproduction data signal.

Reference numeral 8 denotes a PLL circuit comprising a phase comparator 5, a LPF 6, and a VCO 7, and the PLL circuit 8 generates a reproduction clock. The phase comparator 5 detects a phase error between the reproduction data signal and the reproduction clock to obtain a continual phase error amount which is a phase error amount at a polarity inversion position of the reproduction data signal.

Reference numeral 9 denotes a pattern detection circuit which detects a pattern of the reproduction data signal from the reproduction data signal and the reproduction clock signal, and 10 denotes a pattern phase error averaging circuit which obtains a pattern average phase error amount that is an average of the continual phase error amounts of the respective patterns, based on the continual phase error amounts outputted from the phase comparator 5 and the output from the pattern detection circuit 9.

Reference numeral 15 denotes a recording light-emission waveform adjustment unit comprising a variable edge determination circuit 11 which determines a recording parameter to be adjusted based on the output from the pattern phase error averaging circuit 10, and a recording pulse generation circuit 12 which adjusts the recording light-emission waveform based on the output from the variable edge determination circuit 11.

Reference numeral 13 denotes a laser driving circuit as a laser driving means, and 14 denotes an asymmetry detection circuit which detects an asymmetry value of the reproduction signal. Reference numeral 16 denotes a recording power setting unit which performs recording power adjustment based on the output from the asymmetry detection circuit 14, and it comprises a recording power adjustment execution circuit 17 and a recording power setting circuit 18 for recording power adjustment.

Reference numeral 19 denotes a recording power adjustment execution judgment circuit which judges whether recording power adjustment should be executed or not, based on the asymmetry value detected by the asymmetry detection circuit 14.

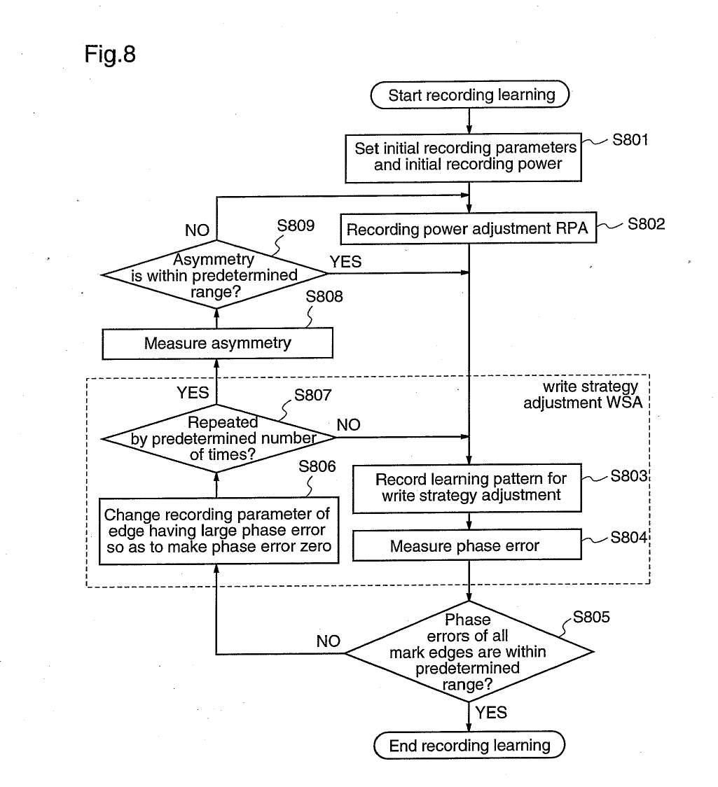

Next, the operation of the information recording/reproduction apparatus 100 of this first embodiment will be described with reference to the configuration diagram of FIG. 1 and a flowchart of FIG. 8 for explaining a recording learning method.

The optical disc device 100 of this first embodiment is different from the conventional optical disc device 200 in that the optical disc device 100 includes the asymmetry recording power adjustment execution judgment circuit 19 which judges whether recording power adjustment should be executed or not in accordance with the output of the asymmetry detection circuit 14, and that asymmetry measurement is performed after recording parameters for write strategy adjustment have been changed in the recording learning method, and recording power adjustment is executed when the obtained asymmetry value is within a predetermined range while no recording power adjustment is executed when the asymmetry value exceeds the predetermined range.

Generally, recording learning is performed for optimizing the write strategy and the recording power so as to obtain an optimum recording quality in advance of data recording. In the recording learning, recording power adjustment and write strategy adjustment are repeated to determine optimum write strategy and recording power.

In this first embodiment, the optical disc device 100 moves the optical head 2 to enable data recording and reproduction in the PCA, and sets initial recording parameters and an initial recording power for performing recording learning (step S801).

Next, recording power adjustment RPA similar to the recording power adjustment RPA performed in the conventional optical disc device 200 is carried out to determine and set an optimum recording power (step S802).

Next, a learning pattern for write strategy adjustment is recorded by the set write strategy (step S803), and thereafter, the learning pattern for write strategy adjustment is reproduced to obtain a reproduction signal. The reproduction signal is shaped by the waveform equalizer 3 shown in FIG. 1, and binarized by the binarization circuit 4 to be a reproduction data signal. The phase comparator 5 shown in FIG. 1 measures a phase error between the reproduction data signal and the reproduction clock signal, based on the inputted reproduction data signal (step S804).

Next, the continual phase error amounts outputted from the phase comparator 5 are averaged by the pattern phase error averaging circuit 10 for each of the patterns detected by the pattern detection circuit 9 to obtain pattern average phase error amounts, and it is judged whether all the pattern average phase error amounts are within a predetermined range or not (step S805), and when all the pattern average phase error amounts are within the predetermined range, the recording learning is ended. On the other hand, when all the pattern average phase error amounts are not within the predetermined range, the variable edge determination circuit 11 determines an edge of a signal pattern having the largest pattern average phase error amount as an edge to be changed, based on the obtained pattern average phase error amounts. At this time, a front edge and a rear edge are separately determined.

Thereafter, the recording pulse generation circuit 12 changes the recording parameters at the front and rear edges which are determined by the variable edge determination circuit 11 so that the phase error should be zero (step S806). The write strategy adjustment WSA comprising the steps S803 to S806 is repeated by a predetermined number of times (step S807) to repeat changing of the recording parameters. The purpose of simultaneously changing the recording parameters at the front edge and the rear edge is to perform the write strategy adjustment WSA with efficiency.

After the predetermined times of recording parameter adjustments are performed as described above, the asymmetry of the area where the learning pattern for write strategy adjustment is recorded with the last recording parameter is measured by the asymmetry detection circuit 14 (step S808).

Next, when the measured asymmetry value is within a predetermined range with respect to a target asymmetry value of recording power adjustment RPA (YES in step S809), the asymmetry recording power adjustment execution judgment circuit 19 judges that it is not necessary to execute recording power adjustment RPA, and instructs the power adjustment execution circuit 17 shown in FIG. 1 to execute no recording power adjustment RPA. The predetermined range includes the asymmetry values having differences from the target asymmetry, which correspond to the adjustment errors in the recording power adjustment RPA. For example, assuming that the adjustment errors in the recording power adjustment RPA are ±0.2 mW for the recording power, no recording power adjustment RPA is performed if the asymmetry value is within a range (e.g., ±1%) corresponding to ±0.2 mW.

Thereby, the frequency of executing the recording power adjustment RPA is decreased, and the recording learning time is reduced and the consumption of the PCA is suppressed.

On the other hand, when the measured asymmetry value is outside the predetermined range with respect to the target asymmetry value of the recording power adjustment RPA (NO in step S809), recording power adjustment RPA is performed as in the conventional device (step S802).

The recording power adjustment RPA and the write strategy adjustment are repeated, and the recording learning is ended at the timing when the phase errors at all the mark edges are within the predetermined range.

While in this first embodiment the recording power adjustment execution judgment means performs judgment using the adjustment error range of the recording power adjustment as the recording power adjustment executable/non-executable judgment range, the recording power adjustment executable/non-executable judgment range may be a range which is determined as having no necessity of recording power adjustment after confirmed in plural optical disc devices.

As described above, according to the information recording/reproduction apparatus of the first embodiment, in the recording learning which includes repeatedly performing the recording power adjustment and the write strategy adjustment, an asymmetry is measured after the write strategy measurement has been performed, and recording power adjustment is not executed when the asymmetry value is within a predetermined range while recording power adjustment is executed when the asymmetry value is outside the predetermined range. Therefore, the execution frequency of recording power adjustment in the recording learning can be reduced, and thereby the time required for recording learning can be shortened, and the consumption of PCA can be suppressed.

### Embodiment 2

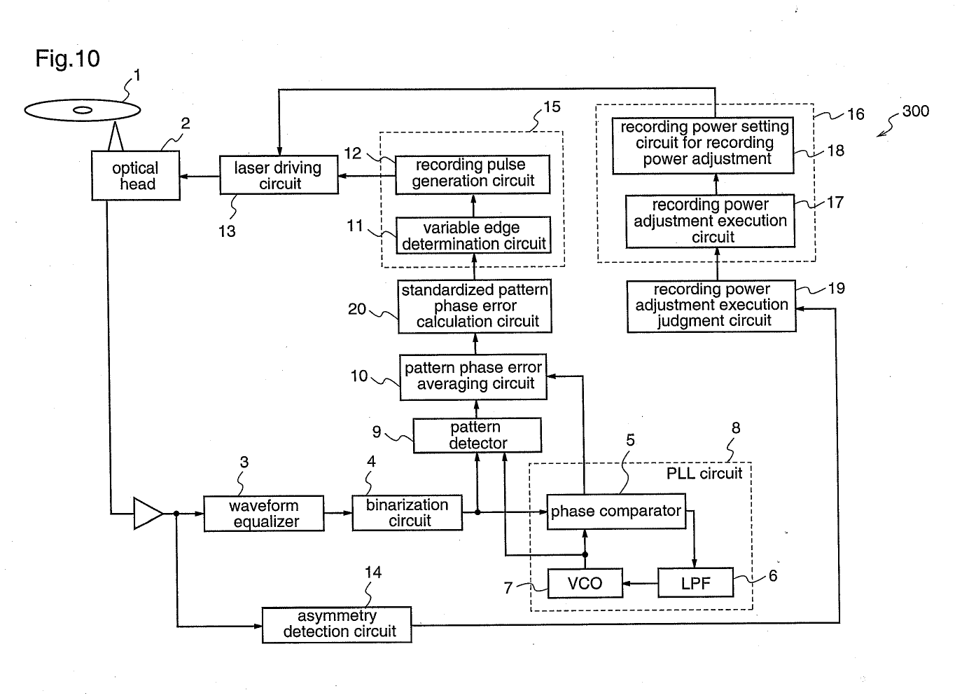

FIG. 10 is a block diagram illustrating the configuration of an optical disc device as an information recording/reproduction apparatus according to a second embodiment of the present invention.

The optical disc device 300 of this second embodiment further includes a standardized pattern phase error calculation circuit 20 in addition to the configuration of the optical disc device 100 of the first embodiment.

The standardized pattern phase error calculation circuit 20 obtains standardized pattern phase error amounts of the respective patterns with reference to the average phase error amounts of the 3s3m pattern and the 3m3s pattern among the pattern average phase error amounts calculated by the pattern phase error averaging circuit 10.

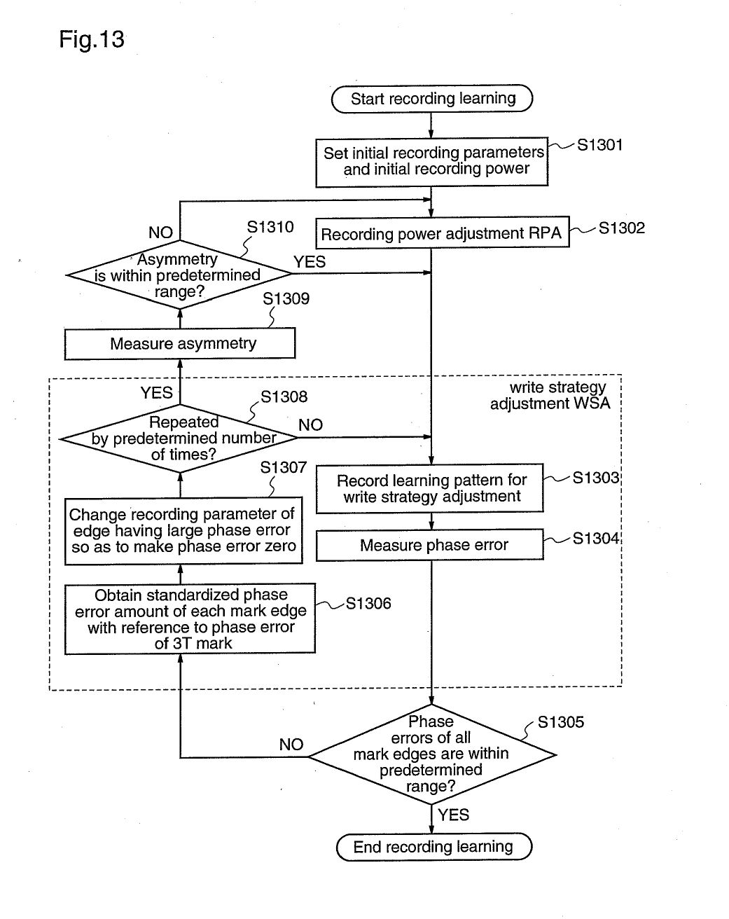

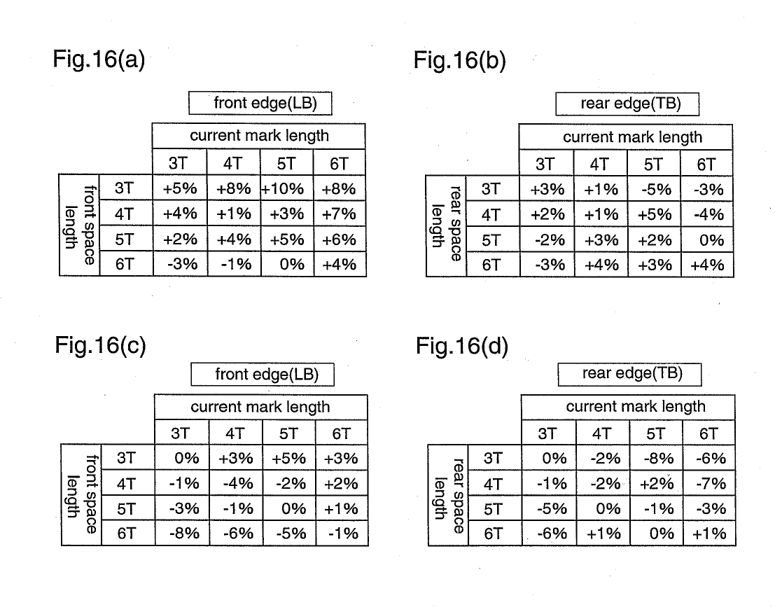

Next, the operation of the optical disc device 300 of this second embodiment will be described using the configuration diagram of FIG. 10, a flowchart of FIG. 13 for explaining a recording learning method, and a pattern phase error table of FIG. 16.

First of all, setting of initial recording parameters and setting of an initial recording power are carried out for performing recording learning (step S1301), and then recording power adjustment RPA is performed, that is, an optimum recording power is determined and set by the recording power setting unit 16 (step S1302).

Next, in write strategy adjustment WSA, initially, a learning pattern for write strategy adjustment is recorded by the set write strategy (step S1303), and thereafter, the learning pattern for write strategy adjustment is reproduced to obtain a reproduction signal, and the reproduction signal is binarized by the binarization circuit 4 to obtain a reproduction data signal, and then a phase error between the reproduction data signal and the reproduction clock signal is measured from the inputted reproduction signal by the phase comparator 5 (step S1304).

Next, the continual phase error amounts outputted from the phase comparator 5 are averaged by the pattern phase error averaging circuit 10 for each pattern detected by the pattern detection circuit 9 to obtain a pattern average phase error amount, and it is judged whether all the pattern average phase error amounts are within a predetermined range or not (step S1305). When all the pattern average phase error amounts are within the predetermined range, the recording learning is ended. On the other hand, when all the pattern average phase error amounts are not within the predetermined range, the standardized pattern phase error calculation circuit 21 performs standardization with reference to the average phase error amounts of the 3s3m pattern and the 3m3s pattern among the obtained pattern average phase error amounts, thereby to obtain standardized phase error amounts (step S1306).

For example, FIGS. 16(a) and 16(b) show the pattern phase error tables obtained by the pattern phase error averaging circuit 10. In the front-edge pattern phase error table, since the average phase error amount of the 3s3m pattern is +5%, the average phase error amounts of the signal patterns other than the front-edge 3s3m pattern are subjected to −5% with reference to this value to obtain the standardized pattern phase error amounts, whereby a standardized pattern phase error table shown in FIG. 16(c) is obtained. Further, also in the rear-edge pattern phase error table, when the standardized pattern phase error amounts are obtained with reference to the average phase error amount of the 3m3s pattern, a standardized pattern phase error table shown in FIG. 16(d) is obtained.

Next, the variable edge determination circuit 11 shown in FIG. 10 determines an edge of a signal pattern having the largest standardized pattern average phase error amount as an edge to be changed. At this time, a front edge and a rear edge are separately determined. Then, the recording pulse generation circuit 12 shown in FIG. 10 changes the recording parameters at the front and rear edges which are determined by the variable edge determination circuit 11 so that the phase error should be zero (step S1307).

The write strategy adjustment WSA comprising the steps S1303 to S1307 is repeated by a predetermined number of times (step S1308) to repeat changing of the recording parameters. The purpose of simultaneously changing the recording parameters at the front edge and the rear edge is to perform the write strategy adjustment WSA with efficiency.

After the predetermined times of recording parameter adjustments are performed as described above, the asymmetry of the area where the learning pattern for write strategy adjustment has been recorded with the last recording parameter is measured by the asymmetry detection circuit 14 (step S1309).

Next, when the measured asymmetry value is within a predetermined range with respect to a target asymmetry value of recording power adjustment RPA (YES in step S1309), the asymmetry recording power adjustment execution judgment circuit 19 judges that it is not necessary to execute recording power adjustment RPA, and instructs the power adjustment execution circuit 17 shown in FIG. 1 so as not to execute recording power adjustment RPA (in the flowchart of FIG. 13, when the judgment result is YES in step S1310, the operation goes to write strategy adjustment WSA without performing step S1302 for recording power adjustment RPA).

At this time, since the edge at which the recording parameter should be changed is determined according to the standardized pattern phase error amount, variation in the asymmetry is suppressed, and the possibility that the measured asymmetry value is within the predetermined range with respect to the target asymmetry value of the recording power adjustment is increased.

The reason is as follows. Since, in general recording data, inversions of shortest recording data such as 3T mark and 3T space occur most frequently, the asymmetry and the recording state of 3T mark are closely related to each other, and therefore, variation in the asymmetry can be suppressed by adjusting the recording parameters with reference to the phase error of 3T mark.

Therefore, when asymmetry measurement is performed after the write strategy adjustment WSA shown in FIG. 13 has been performed, variations of the asymmetry can be reduced, and thereby the probability that the asymmetry value is within the predetermined range is increased, and the frequency of executing the recording power adjustment RPA is reduced, whereby the recording learning time is reduced and the consumption of PCA is also reduced.

On the other hand, if it is judged that the asymmetry value measured in step S1309 is outside the predetermined range (NO in step S1310), recording power adjustment RPA is executed as in the conventional device (step S1302).

Then, the recording power adjustment RPA and the write strategy adjustment WSA are repeated, and the recording learning is ended at the timing when all the mark edge phase errors are within the predetermined range.

As described above, according to the information recording/reproduction apparatus of the second embodiment, the standardized pattern phase error calculation circuit is added to the configuration of the information recording/reproduction apparatus of the first embodiment, and the recording light-emission waveform is adjusted by the recording light-emission waveform adjustment means based on the output of the standardized pattern phase error calculation means, and recording power adjustment is not performed when the recording power adjustment execution judgment means judges that the recording state outputted from the asymmetry detection means is within a predetermined range. Since the asymmetry is measured after the write strategy adjustment and no recording power adjustment is performed if the asymmetry is smaller than a predetermined asymmetry value, the time required for recording learning is reduced, and the consumption of PCA is also suppressed.

Furthermore, the standardized pattern phase error calculation means performs standardization for the output of the pattern phase error averaging means with reference to the phase error average values of the pattern comprising the shortest mark and the shortest space at the front edge of the mark and the pattern comprising the shortest mark and the shortest space at the rear edge of the mark to obtain the standardized pattern phase error, and adjusts the write strategy with reference to the standardized pattern phase error of the shortest mark length relating to the asymmetry. Therefore, asymmetry variation in the write strategy adjustment can be suppressed, and thereby the recording power adjustment amount by the recording power adjustment is reduced and thus deviation of the phase error due to the recording power adjustment is decreased, resulting in more accurate write strategy adjustment.

### Embodiment 3

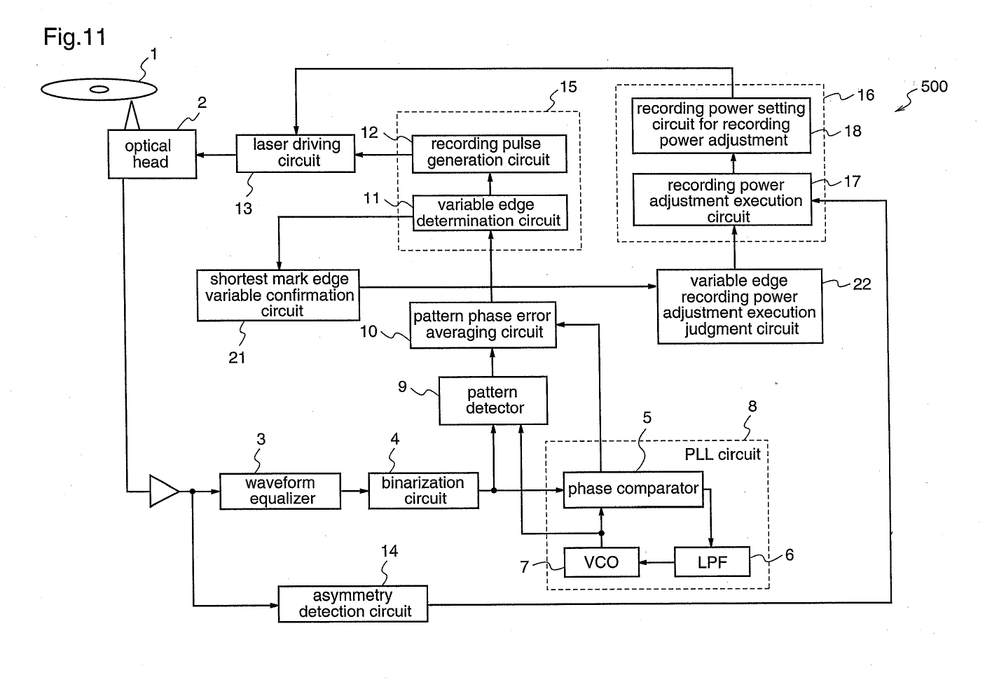

FIG. 11 is a diagram illustrating the configuration of an optical disc device as an information recording/reproduction apparatus according to a third embodiment.

The optical disc device 500 of this third embodiment is provided with a shortest mark edge variable confirmation circuit 21 and a variable edge recording power adjustment execution judgment circuit 22 instead of the recording power adjustment execution judgment circuit 19 in the configuration of the optical disc device 100 of the first embodiment.

The shortest mark edge variable confirmation circuit 21 judges whether the recording parameter relating to 3T mark is changed or not in write strategy adjustment at a certain recording power, and outputs the result of judgement.

The variable edge recording power adjustment execution judgment circuit 22 instructs the recording power setting unit 16 so as to perform recording power adjustment when the recording parameter relating to 3T mark is changed, and so as not to perform recording power adjustment when the recording parameter relating to 3T mark is not changed.

The reason is as follows. Since, in general recording data, inversions of shortest recording data such as 3T mark and 3T space occur most frequently, the asymmetry and the recording state of 3T mark are closely related to each other, and therefore, it can be estimated that variation in the asymmetry is small when the recording parameter relating to 3T mark is not adjusted.

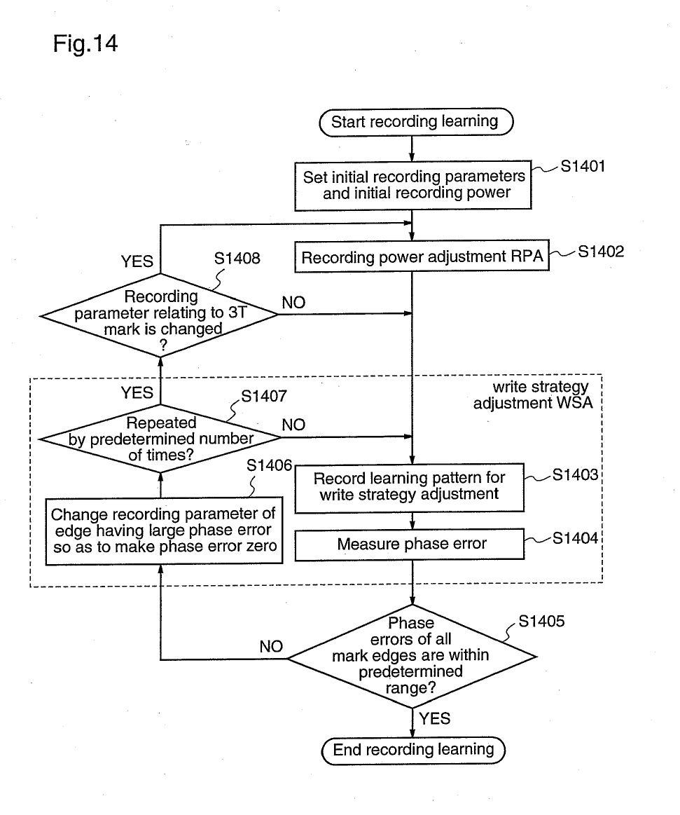

Next, the operation of the optical disc device 500 of this third embodiment will be described with reference to the configuration diagram of FIG. 11, and a flowchart of FIG. 14 for explaining the recording learning method.

First of all, setting of initial recording parameters and setting of an initial recording power are carried out for performing recording learning (step S1401), and then recording power adjustment RPA is performed, i.e., the recording power setting unit 16 determines and sets an optimum recording power (step S1402).

Next, in write strategy adjustment WSA, initially, a learning pattern for write strategy adjustment is recorded by the set write strategy (step S1403), and the learning pattern for write strategy adjustment is reproduced to obtain a reproduction signal and the reproduction signal is binarized by the binarization circuit 4 to obtain a reproduction data signal, and then a phase error between the reproduction data signal and the reproduction clock signal is measured based on the inputted reproduction data signal by the phase comparator 5 (step S1404).

Next, the continual phase error amounts outputted from the phase comparator 5 are averaged by the pattern phase error averaging circuit 10 for each of the patterns detected by the pattern detection circuit 9 to obtain pattern average phase error amounts, and it is judged whether all the pattern average phase error amounts are within a predetermined range or not (step S1405), and when all the pattern average phase error amounts are within the predetermined range, the recording learning is ended.

On the other hand, when all the pattern average phase error amounts are outside the predetermined range, the variable edge determination circuit 11 determines an edge of a signal pattern having the largest pattern average phase error amount as an edge to be changed, based on the obtained pattern average phase error amounts. At this time, a front edge and a rear edge are separately determined. Then, the recording pulse generation circuit 12 changes the recording parameters at the front and rear edges which are determined by the variable edge determination circuit 11 so that the phase errors should be zero (step S1406).

The write strategy adjustment WSA comprising the steps S1403 to S1406 are repeated by a predetermined number of times (step S1407), thereby to repeat changing of the recording parameters. At this time, the purpose of simultaneously changing the recording parameters at the front and rear edges is to perform the write strategy adjustment WSA with efficiency.

After the recording parameter adjustment is repeated by the predetermined number of times, the shortest mark edge variable confirmation circuit 22 compares the recording parameter obtained by the previous recording power adjustment with the recording parameter obtained by repeating the recording parameter adjustment by the predetermined number of times, thereby to confirm whether the recording parameters (LB33,TB33) at the edges of the 3s3m pattern and the 3m3s pattern are changed or not (step S1408).

When the edges of the 3s3m pattern and the 3m3s pattern are not changed (NO in step S1408), the variable edge recording power adjustment execution judgment circuit 20 estimates that variation of the asymmetry is small, and does not perform recording power adjustment RPA. When the edges of these patterns are changed (YES in step S1408), the variable edge recording power adjustment execution judgment circuit 20 estimates that the asymmetry is varied, and instructs the recording power adjustment execution circuit 17 to perform the recording power learning similar to that of the conventional device.

The reason why recording power adjustment is not performed depending on presence/absence of change of the recording parameter of the signal pattern relating to 3T mark as the shortest mark is as follows. Since, in general recording data, inversions of shortest recording data such as 3T mark and 3T space occur most frequently, the asymmetry and the recording state of 3T mark are closely related to each other, and therefore, it can be estimated that variation in the asymmetry is small depending on presence/absence of adjustment of the recording parameter relating to 3T mark.

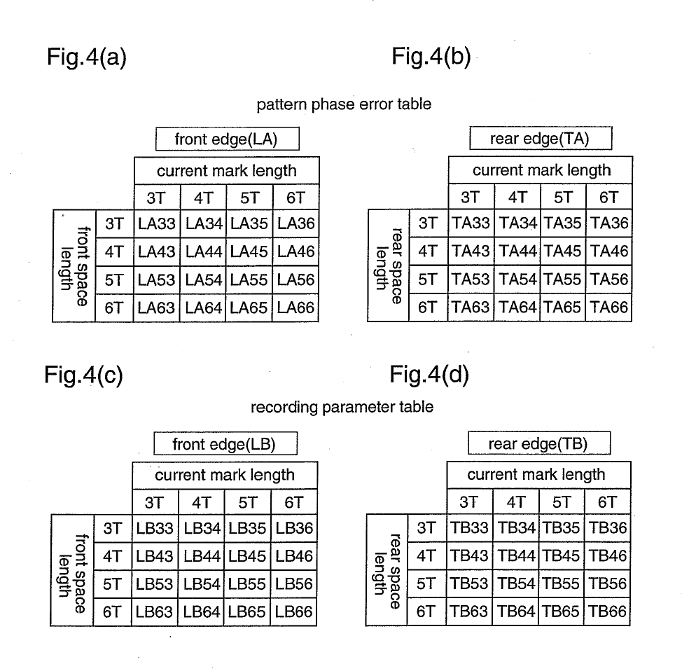

Since no recording power adjustment RPA is performed when the recording parameter relating to 3T mark is not changed after the write strategy adjustment shown in FIG. 4, the frequency of performing the recording power adjustment RPA is reduced, whereby the recording learning time is reduced, and the consumption of the PCA is also suppressed.

As described above, according to the information recording/reproduction apparatus of the third embodiment, after the write strategy is adjusted, it is confirmed whether the recording parameter relating to 3T mark is adjusted or not in the write strategy adjustment, and when the recording parameter relating to 3T mark is not adjusted, recording power adjustment is not performed assuming less asymmetry variation, while recording power adjustment is performed when the recording parameter relating to 3T mark is adjusted. Therefore, the frequency of executing the recording power adjustment in the recording learning can be reduced, and consequently, the recording learning time can be shortened, and the consumption of PCA can be suppressed.

### Embodiment 4

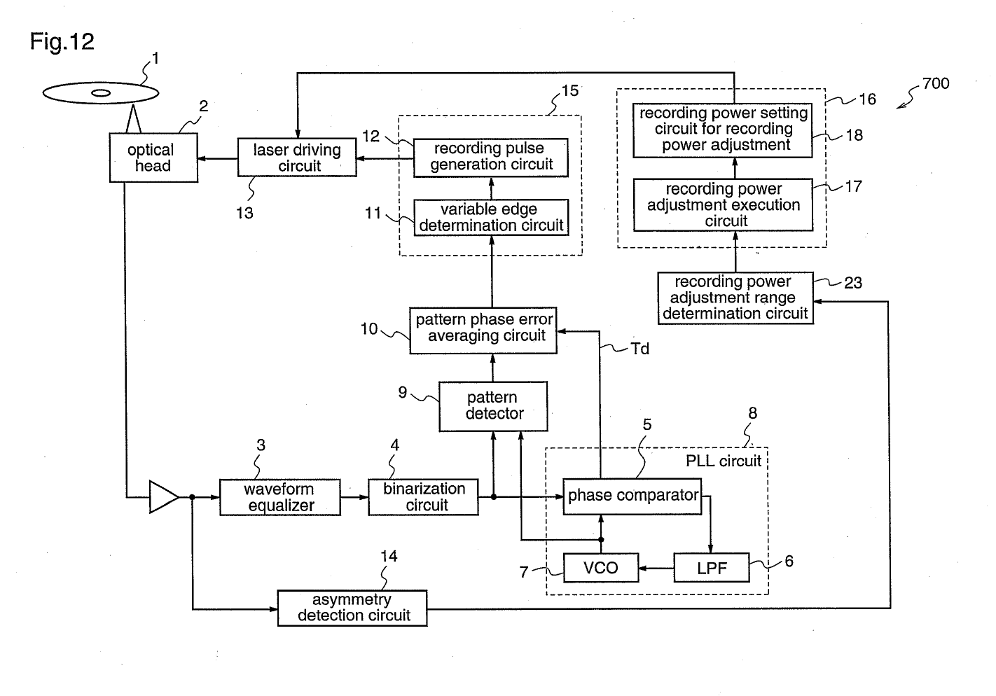

FIG. 12 is a diagram illustrating the configuration of an optical disc device as an information recording/reproduction apparatus according to a fourth embodiment.

A major difference of the optical disc device 700 of this fourth embodiment from the optical disc device 100 of the first embodiment is that the optical disc device 700 is provided with a recording power adjustment range determination circuit 23.

The recording power adjustment range determination circuit 23 judges whether recording power adjustment should be executed or not according to the output of the asymmetry detection circuit 14, and when it is judged that recording power adjustment is necessary, the recording power adjustment range determination circuit 23 varies the range of changing the recording power according to the output of the asymmetry detection circuit 14.

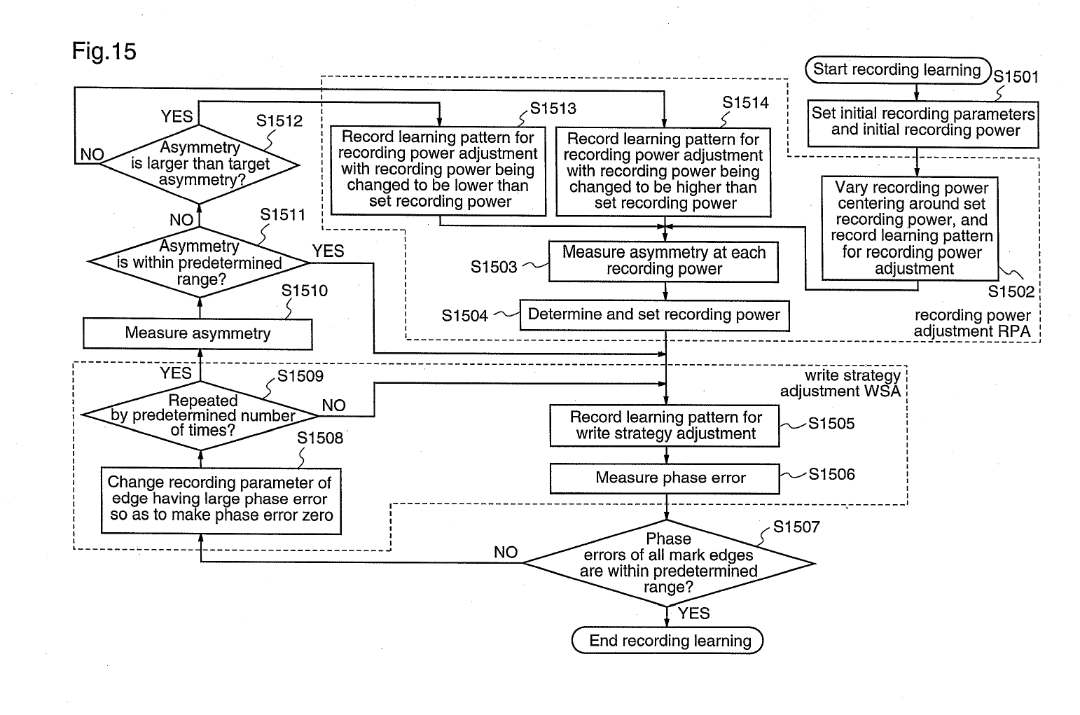

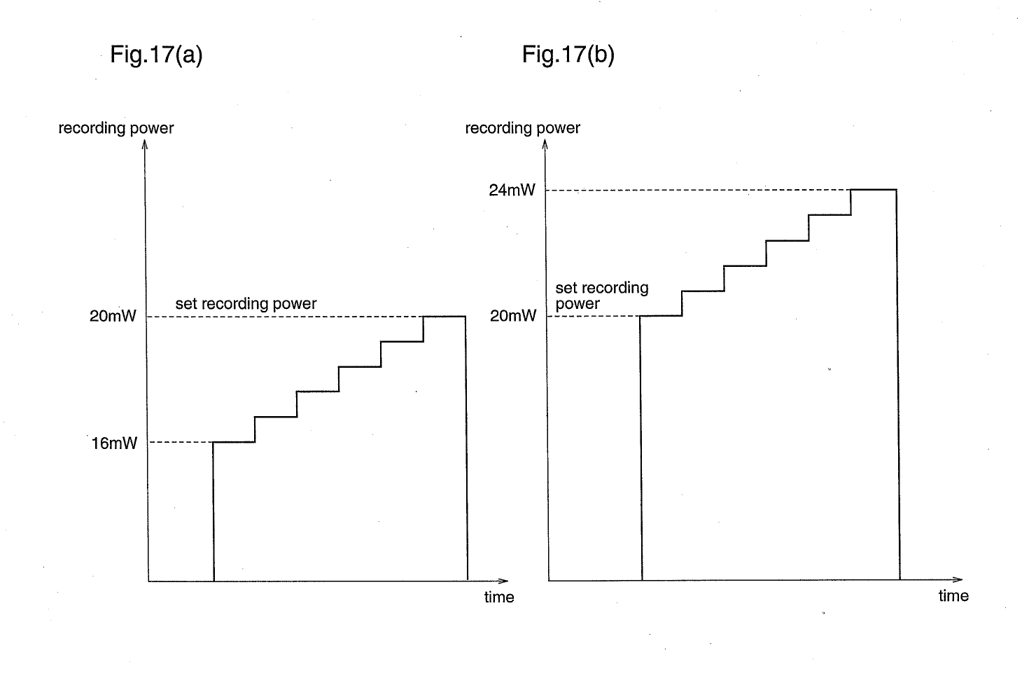

Next, the operation of the optical disc device 700 of this fourth embodiment will be described with reference to the configuration diagram of FIG. 12, a flowchart of FIG. 15 for explaining a recording learning method, and a diagram of FIG. 17 for explaining recording power adjustment.

Initially, setting of initial recording parameters and setting of initial recording power are performed for starting recording learning (step S1501). Next, an optimum recording power is determined and set (step S1504) through step S1502 for recording the recording power learning pattern with the recording power being varied centering around the set recording power and step S1503 for measuring an asymmetry of each recording power (step S1504).

Then, in the write strategy adjustment WSA, the learning pattern for write strategy adjustment is recorded by the set write strategy (step S1505), and the learning pattern for write strategy is reproduced to obtain a reproduction signal, and then the reproduction signal is binarized by the binarization circuit 4 to obtain a reproduction data signal. The phase comparator 5 measures a phase error between the reproduction data signal and the reproduction clock signal based on the inputted reproduction data signal (step S1506).

Next, the continual phase error amounts outputted from the phase comparator 5 are averaged by the pattern phase error averaging circuit 10 for each of the patterns detected by the pattern detection circuit 9 to obtain pattern average phase error amounts, and it is judged whether all the pattern average phase error amounts are within a predetermined range or not (step S1507). When all the pattern average phase error amounts are within the predetermined range, the recording learning is ended.

On the other hand, when all the pattern average phase error amounts are not within the predetermined range, the variable edge determination circuit 11 determines an edge of a signal pattern having the largest pattern average phase error amount as an edge which is to be changed, based on the obtained pattern average phase error amounts. At this time, a front edge and a rear edge are separately determined.

The recording pulse generation circuit 12 shown in FIG. 12 changes the recording parameters of the front and rear edges which are determined by the variable edge determination circuit 11 so that the phase errors should be zero (step S1508).

The write strategy adjustment WSA comprising the above-mentioned steps S1505 to S1508 is repeated by a predetermined number of times to repeat changing of the recording parameters (step S1509). The purpose of simultaneously changing the recording parameters at the front and the rear edges is to perform the write strategy adjustment WSA with efficiency.

After the recording parameter adjustment is repeated by the predetermined number of times as described above, the asymmetry of the area where the learning pattern for write strategy adjustment has been recorded with the last recording parameter is measured by the asymmetry detection circuit 14 (step S1510).

Next, the asymmetry recording power adjustment execution judgment circuit 19 judges that no recording power adjustment is necessary if the measured asymmetry value is within a predetermined range with respect to the target asymmetry value of the recording power adjustment (YES in step S1511), and instructs the power adjustment execution circuit 17 not to perform recording power adjustment RPA, i.e., to go to the step of write strategy adjustment WSA without going to the step of recording power adjustment RPA. When the measured asymmetry is outside the predetermined range (NO in step S1304), the asymmetry recording power adjustment execution judgment circuit 19 instructs the power adjustment execution circuit 17 to go to the step of recording power adjustment RPA.

When the recording power adjustment RPA is performed, the recording power adjustment range determination circuit 23 compares the measured asymmetry value with the target asymmetry value in the recording power adjustment RPA. When the measured asymmetry value is larger than the target asymmetry value (YES in step S1512), the operation goes to step S1513, and the recording power range of the recording power adjustment RPA is set to a range smaller than the set recording power to perform determination of the recording power and recording of the learning pattern for recording power adjustment. When the measured asymmetry is smaller than the target asymmetry value (NO in step S1512), the operation goes to step S1514, and the recording power range of the recording power adjustment RPA is set to a range larger than the set recording power to perform determination of the recording power and recording of the learning pattern for recording power adjustment.

Since the recording power must be reduced if the measured asymmetry value is larger than the target asymmetry value, the recording power adjustment range should be adjusted so that the recording power becomes smaller than the set recording power. For this purpose, the recording power range in the recording power adjustment RPA is set to a range of −20% from the set recording power, and recording is performed with the recording power being varied by 4%.

Further, since the recording power must be increased if the measured asymmetry value is smaller than the target asymmetry value, the recording power adjustment range should be adjusted so that the recording power becomes larger than the set recording power. For this purpose, the recording power range in the recording power adjustment RPA is set to a range of +20% from the set recording power, and recording is performed with the recording power being varied by 4%.

For example, assuming that the set recording power is 20 mW, recording is performed with the recording power being varied as shown in FIG. 17(a) when the measured asymmetry value is larger than the target asymmetry value, while recording is performed with the recording power being varied as shown in FIG. 17(b) when the measured asymmetry value is smaller than the target asymmetry value.

The reason is as follows. Performing the asymmetry measurement after the write strategy adjustment makes it possible to judge whether the set recording power is larger than the recording power of the target asymmetry value or not when recording is performed with the recording parameter which has been determined in the write strategy adjustment WSA before performing the recording power adjustment.

Thereby, since the recording power range can be restricted when the recording power adjustment RPA is executed, the recording power adjustment time is reduced, and consumption of the PCA can be suppressed.

According to the information recording/reproduction apparatus of the fourth embodiment, the recording power adjustment range determination circuit as a recording power adjustment range determination means is provided in the information recording/reproduction apparatus of the first embodiment, and the recording power range in the recording power adjustment is made smaller than the set recording power when the recording power in the recording state as an output from the asymmetry detection means is larger than the predetermined recording state, while the recording power range in the recording power adjustment is made larger than the set recording power when the recording power is smaller than the predetermined recording state. Therefore, a difference between the asymmetry value at the current set recording power and the target asymmetry value can be obtained, whereby the recording power variable range in the recording power adjustment can be limited, and thus the consumption of PCA can be suppressed and the time required for recording power adjustment can be reduced.

### APPLICABILITY IN INDUSTRY

An information recording/reproduction apparatus of the present invention can reduce the time required for recording learning which obtains a recording condition suited to the characteristics of an optical disc as a recording target, and can suppress consumption of PCA. Therefore, it is effective in reducing the time from reception of a data recording instruction to start of actual recording in an optical disc device.

1. An information recording/reproduction apparatus for reproducing information from a waveform signal which is recorded by a mark edge recording method having information at front edges and rear edges of marks formed on a recording medium, said apparatus comprising:
a laser driving circuit which irradiate a recording plane of the recording medium with laser light to record recording data;
an asymmetry detection circuit which detects a recording state that varies according to a recording power, from a reproduction signal reproduced from the recording medium;
a recording power setting circuit which performs recording power adjustment based on an output of the asymmetry detection circuit;
a reproduction clock generation circuit which generates a reproduction clock based on the reproduction signal;
a phase error detection circuit which detects a phase error between the reproduction signal and the reproduction clock, based on the reproduction signal and the reproduction clock;
a pattern detection circuit which detects patterns of the reproduction signal, based on the reproduction signal and the reproduction clock;
a pattern phase error averaging circuit which obtains an average of phase errors for each pattern, from an output of the pattern detection circuit and an output of the phase error detection circuit;
a recording light-emission waveform adjustment circuit which adjusts a recording light-emission waveform based on an output of the pattern phase error averaging circuit; and
a recording power adjustment execution judgment circuit which controls the recording power setting circuit so as to perform recording power adjustment when the detected recording state is outside a predetermined range, and controls the recording power setting circuit so as not to perform recording power adjustment when the detected recording state is within the predetermined range.

2. An information recording/reproduction apparatus as defined in claim 1, wherein
said recording power adjustment execution judgment circuit controls the recording power setting circuit so as to perform recording power adjustment when the detected recording state is outside a range corresponding to a recording power of an adjustment error in recording power adjustment, and controls the recording power setting circuit so as not to perform recording power adjustment when the detected recording state is within the range corresponding to the recording power of the adjustment error in the recording power adjustment.

3. An information recording/reproduction apparatus for reproducing information from a waveform signal which is recorded by a mark edge recording method having information at front edges and rear edges of marks formed on a recording medium, said apparatus comprising:
a laser driving circuit which irradiate a recording plane of the recording medium with laser light to record recording data;
an asymmetry detection circuit which detects a recording state that varies according to a recording power, from a reproduction signal reproduced from the recording medium;
a recording power setting circuit which performs recording power adjustment based on an output of the asymmetry detection circuit;
a reproduction clock generation circuit which generates a reproduction clock based on the reproduction signal;
a phase error detection circuit which detects a phase error between the reproduction signal and the reproduction clock, based on the reproduction signal and the reproduction clock;
a pattern detection circuit which detects patterns of the reproduction signal based on the reproduction signal and the reproduction clock;
a pattern phase error averaging circuit which obtains an average of phase errors for each pattern, from an output of the pattern detection circuit and an output of the phase error detection circuit;
a standardized pattern phase error calculation circuit which standardizes an output of the pattern phase error averaging circuit with reference to a phase error average value of a shortest mark;
a recording light-emission waveform adjustment circuit which adjusts a recording light-emission waveform based on an output of the standardized pattern phase error calculation circuit; and
a recording power adjustment execution judgment circuit which controls the recording power setting circuit so as to perform recording power adjustment when the detected recording state is outside a predetermined range, and controls the recording power setting circuit so as not to perform recording power adjustment when the detected recording state is within the predetermined range.

4. An information recording/reproduction apparatus as defined in claim 3, wherein
said recording power adjustment execution judgment circuit controls the recording power setting circuit so as to perform recording power adjustment when the detected recording state is outside a range corresponding to a recording power of an adjustment error in recording power adjustment, and controls the recording power setting circuit so as not to perform recording power adjustment when the detected recording state is within the range corresponding to the recording power of the adjustment error in the recording power adjustment.

5. An information recording/reproduction apparatus as defined in claim 3, wherein
said standardized pattern phase error calculation circuit standardizes the output of the pattern phase error averaging circuit with reference to the phase error average values of a pattern comprising a shortest mark and a shortest space at an front edge of the shortest mark and a pattern comprising a shortest mark and a shortest space at a rear edge of the shortest mark.

6. An information recording/reproduction apparatus for reproducing information from a waveform signal which is recorded by a mark edge recording method having information at front edges and rear edges of marks formed on a recording medium, said apparatus comprising:
a laser driving circuit which irradiate a recording plane of the recording medium with laser light to record recording data;
an asymmetry detection circuit which detects a recording state that varies according to a recording power, from a reproduction signal reproduced from the recording medium;
a recording power setting circuit which performs recording power adjustment based on an output of the asymmetry detection circuit;
a reproduction clock generation circuit which generates a reproduction clock based on the reproduction signal;
a phase error detection circuit which detects a phase error between the reproduction signal and the reproduction clock, based on the reproduction signal and the reproduction clock;
a pattern detection circuit which detects patterns of the reproduction signal based on the reproduction signal and the reproduction clock;
a pattern phase error averaging circuit which obtains an average of phase errors for each pattern, from an output of the pattern detection circuit and an output of the phase error detection circuit;
a recording light-emission waveform adjustment circuit which adjusts a recording light-emission waveform based on an output of the pattern phase error averaging circuit;
a recording light-emission waveform adjustment execution confirmation circuit which judges whether or not a recording light-emission waveform relating to a shortest mark has been adjusted in the recording light-emission waveform adjustment circuit; and
a recording power adjustment execution judgment circuit which receives the result of judgment by the recording light-emission waveform adjustment execution confirmation circuit, and controls the recording power setting circuit so as to perform recording power adjustment when the recording light-emission waveform relating to the shortest mark is adjusted, and controls the recording power setting circuit so as not to perform recording power adjustment when the recording light-emission waveform relating to the shortest mark is not adjusted.

7. An information recording/reproduction apparatus as defined in claim 6, wherein
said recording light-emission waveform adjustment execution confirmation circuit confirms whether the recording light-emission waveforms of a pattern comprising a shortest mark and a shortest space at an front edge of the shortest mark and a pattern comprising a shortest mark and a shortest space at a rear edge of the shortest mark are adjusted or not.

8. An information recording/reproduction apparatus for reproducing information from a waveform signal which is recorded by a mark edge recording method having information at front edges and rear edges of marks formed on a recording medium, said apparatus comprising:
a laser driving circuit which irradiate a recording plane of the recording medium with laser light to record recording data;
an asymmetry detection circuit which detects a recording state that varies according to a recording power, from a reproduction signal reproduced from the recording medium;
a recording power setting circuit which performs recording power adjustment based on an output of the asymmetry detection circuit;
a reproduction clock generation circuit which generates a reproduction clock based on the reproduction signal;
a phase error detection circuit which detects a phase error between the reproduction signal and the reproduction clock, based on the reproduction signal and the reproduction clock;
a pattern detection circuit which detects patterns of the reproduction signal based on the reproduction signal and the reproduction clock;
a pattern phase error averaging circuit which obtains an average of phase errors for each pattern, from an output of the pattern detection circuit and an output of the phase error detection circuit;
a recording light-emission waveform adjustment circuit which adjusts a recording light-emission waveform based on an output of the pattern phase error averaging circuit; and
a recording power adjustment range determination circuit which controls the recording power setting circuit so as to perform recording power adjustment when the detected recording state is outside a predetermined range, and controls the recording power setting circuit so as not to perform recording power adjustment when the detected recording state is within the predetermined range, and
when performing control so as to perform recording power adjustment, said recording power adjustment range determination circuit setting the recording power variable range in the recording power adjustment to be lower than a set recording power when the detected recording state is larger than a predetermined value, and setting the recording power variable range in the recording power adjustment to be higher than the set recording power when the detected recording state is smaller than the predetermined value.

9. An information recording/reproduction apparatus as defined in claim 8, wherein
said recording power adjustment range determination circuit controls the recording power setting circuit so as to perform recording power adjustment when the detected recording state is outside a recording state corresponding to a recording power of an adjustment error in the recording power adjustment, and controls the recording power setting circuit so as not to perform recording power adjustment when the detected recording state is within the recording state corresponding to the recording power of the adjustment error in the recording power adjustment.

10. An information recording/reproduction apparatus as defined in claim 4, wherein
said standardized pattern phase error calculation circuit standardizes the output of the pattern phase error averaging circuit with reference to the phase error average values of a pattern comprising a shortest mark and a shortest space at an front edge of the shortest mark and a pattern comprising a shortest mark and a shortest space at a rear edge of the shortest mark.
